(19) United States
(12) Patent Application Publication
(10) Pub. No.: US 2011/0031057 A1
(43) Pub. Date: Feb. 10, 2011

(54) Structure for stabilizing a center of gravity of a remote car body

(76) Inventor: Daimler Chu, Taipei County (TW)

Correspondence Address: LEONG C. LEI, PMB # 1008, 1839 YGNACIO VALLEY ROAD, WALNUT CREEK, CA, 94598, US

(21) Appl. No.: 11/826,040

(22) Filed: Jul. 11, 2007

(51) Int. Cl. B62D 21/00

(52) U.S. Cl. 180/312

(57) ABSTRACT

A structure for stabilizing a center of gravity of a remote car has a chassis, a side of which is provided with a plurality of assembly holes; a bearer, which is provided with two standing edges of different heights, and a bottom surface and a top surface of which are provided respectively with a plurality of assembly holes. Through screw members, the bearer is assembled on the chassis of the remote car, and an engine body is assembled into the bearer, allowing the three to be formed into one entity. Therefore, through the unequal height standing edges at two sides of the bearer, the engine body is assembled in a titled fashion, enabling a center of gravity of the engine body to be located at a central position of the chassis.

### BACKGROUND OF THE INVENTION

(a) Field of the Invention

The present invention relates to a structure for stabilizing a center of gravity, and more particularly to a structure for stabilizing a center of gravity of a remote car body or similar structure.

(b) Description of the Prior Art

A chassis of a remote car is a flat plate in a rectangular shape, a front and a rear end of the plate are provided respectively an axle, and two tail ends of the axles are pivoted with a wheel, respectively; whereas, an engine body which controls rotation of the wheels is assembled on the chassis.

Referring to FIG. 5, a conventional remote car structure includes primarily a chassis A on which is provided with two equal height pillars B, with top surfaces of the two pillars B being disposed with screw holes. Through screw members D, an engine body C is screwed on the two pillars B, such that the engine body C can be firmly assembled on the chassis A of the remote car, and power of the engine body C can be transmitted to a front and a rear wheel, thereby driving the remote car to move forward by the engine.

However, as the heights for the two pillars B on the chassis A of the remote car are set to be equal, the weight of engine after the engine body C is screwed and fixed on the chassis A is distributed between the two pillars B. As a center of the chassis A should be disposed with a central differential transmission rod, after two pillars are installed at two sides, and the engine body C is fixed, a center of gravity of the remote car will lean to a side according to an installation position of the engine body C. When the remote car moves forward or backward along a straight line in high speed, the weight of the engine body C will directly drop downward, without affecting stability of the remote car upon moving in high speed. On the other hand, when the car is to turn, due to the effect of centrifugal force in turning, the center of gravity of the conventional remote car will lean to a side. Furthermore, while the remote car is turning upon moving in high speed, the center of gravity of the remote car will further lean to one side, causing the remote car to be unstable and turning over, which is very imperfect.

Accordingly, a structure for stabilizing a center of gravity of a remote car body is designed and assembled, so as to provide for general consumers to use.

### SUMMARY OF THE INVENTION

The primary object of the present invention is to provide a structure for stabilizing a center of gravity of a remote car body, allowing that no matter under what kind of situation; the center of gravity will be located at a central position of the remote car upon moving in high speed.

Accordingly, the structure for stabilizing the center of gravity of the remote car body includes a chassis, a side of which is provided with a plurality of assembly holes; and a bearer, which is provided with two standing edges of different heights, and a bottom surface and a top surface of which are provided respectively a plurality of assembly holes. Through screw members, the bearer is assembled on the chassis of the remote car, and an engine body is assembled on the bearer, to form the three into one entity. Accordingly, through the unequal height standing edges at two sides of the bearer, the engine body is assembled and fixed on the chassis in a tilted fashion, allowing a center of gravity of the engine body to be exactly located at a central position of the chassis, so as to achieve an effect that the remote car body can be more stabilized in moving, no matter whether it is moving in a straight line or is turning.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of an embodiment of the present invention.

FIG. 2 shows a perspective view of an embodiment of the present invention after being assembled.

FIG. 3 shows a side cutaway view of an embodiment of the present invention after being assembled.

FIG. 4 shows a schematic view of distribution of a center of gravity for an embodiment of the present invention.

FIG. 5 shows a cutaway view at an installation side of an engine of a conventional remote car.

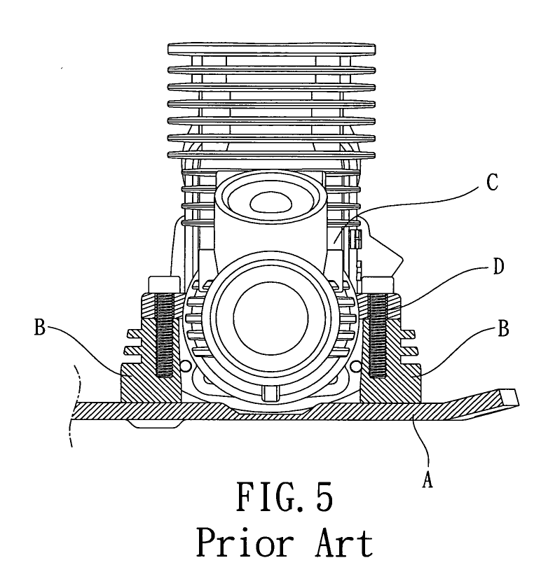

### DETAILED DESCRIPTION OF THE PREFERRED EMBODIMENTS

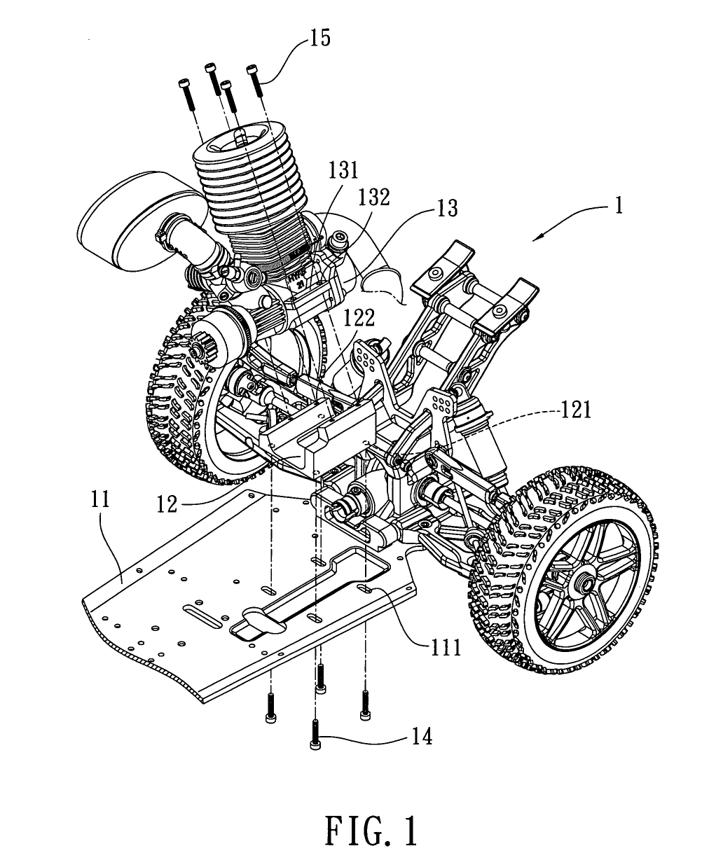

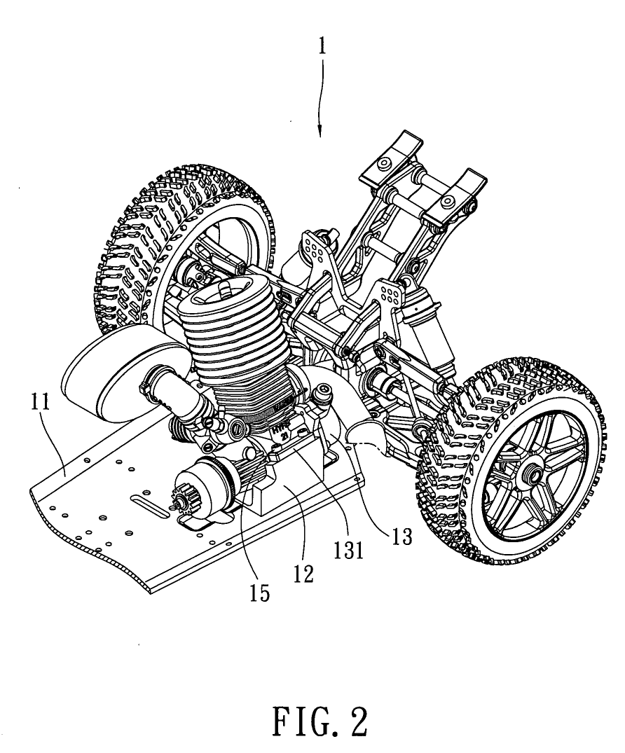

Referring to FIG. 1 and FIG. 2, an engine part of a remote car 1 of the present invention comprises a chassis 11, a bearer 12, an engine body 13, and a plurality of screw members 14. Proper positions at a side of the chassis 11 are provided with a plurality of assembly holes 111, a cross section of the bearer 12 is formed as a U-shape frame, standing edges at two sides of the U-shape frame are configured as different heights, or as one higher and the other one lower, and top parts of the two standing edges are provided with a tilted angle. A bottom surface of the bearer 12 is provided with a plurality of assembly holes 121, top surfaces of the two standing edges are provided with a plurality of assembly holes 122, and a left and a right side of the engine body 13 are protruded respectively with an assembly piece 131, with an opposite position on the assembly piece 131 being disposed with an assembly hole 132.

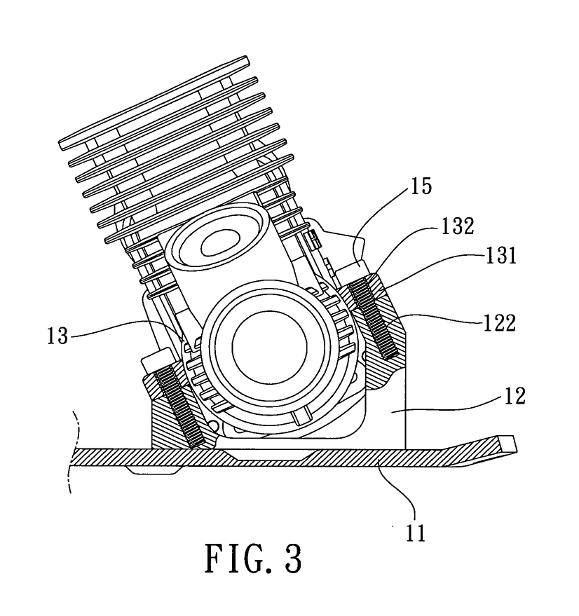

The bearer 12 will align the assembly holes 131 on the bottom surface with the assembly holes 111 on the chassis 11. Through the plural screw members 14, the bearer 12 is assembled on the chassis 11. On the other hand, the engine body 13 is emplaced on the bearer 12, allowing the assembly pieces 131 at two sides of the engine body 13 to bridge on the top surfaces of the standing edges at two sides of the bearer 12. Then, through screw members 15, the assembly holes on the assembly pieces 131 are assembled with the assembly holes 122 on the top surface of the standing edges of the bearer 12 into one entity, allowing the engine body 13 to be assembled on the chassis 11 in a tilted configuration, as shown in FIG. 3.

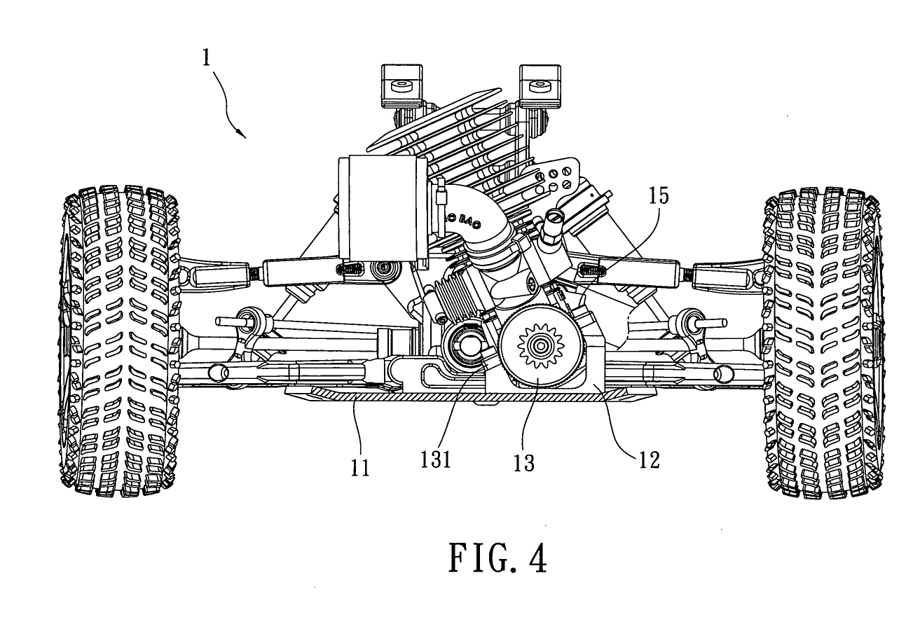

Referring to FIG. 4, the engine body 13 of the remote car 1 is assembled on the chassis 11 in a tilted fashion, through the bearer 12, and the bearer 12 is assembled at a side of the chassis 11; therefore, a center of gravity of the engine body 13 is exactly located at a central position of the remote car 1, allowing that a center of gravity of the remote car 1 will be firmly located at the central position no matter under what kind of condition (such as moving along a straight line in high speed, or turning in high speed) the remote car 1 is, without freely changing a center of gravity of the remote car 1 from turning, thereby effectively overcoming a shortcoming that the remote car 1 will be turned over by turning, or a shifting of the center of gravity.

It is worth to be noted that in another feasible embodiment, the bearer 12 can be separated and configured with two unequal height standing edges which can be similarly assembled as the structure for stabilizing the center of gravity of the remote car body, according to the present invention.

Accordingly, the present invention actually provides a structure for stabilizing a center of gravity of a remote car body to achieve an expected object of the invention, and is indeed provided with practicability.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A structure for stabilizing a center of gravity of a remote car body comprising a chassis, a side of which is provided with a plurality of assembly holes; a bearer, which is provided with two standing edges of different heights, and a bottom surface and a top surface of which are provided respectively with a plurality of assembly holes; through screw members, the bearer being assembled on the chassis of the remote car, and an engine body being assembled on the bearer, allowing the three to be formed into one entity.

2. The structure for stabilizing a center of gravity of a remote car body according to claim 1, wherein the bearer is a U-shape frame, two sides of which are provided with two standing edges of different heights, with top parts of the two standing edges being provided with tilted angles.

3. The structure for stabilizing a center of gravity of a remote car body according to claim 1, wherein the bearer is separable and is provided with two unequal height standing edges.
